(19) United States
(12) Patent Application Publication
(10) Pub. No.: US 2020/0182374 A1
(43) Pub. Date: Jun. 11, 2020

(54) VALVE

(71) Applicant: EISELE PNEUMATICS GMBH & CO. KG, Waiblingen (DE)

(72) Inventor: Klaus HARSCH, Winnenden (DE)

(73) Assignee: EISELE PNEUMATICS GMBH & CO. KG, Waiblingen (DE)

(21) Appl. No.: 16/316,725

(22) PCT Filed: Jun. 29, 2017
(86) PCT No.: PCT/EP2017/000780

§ 371 Date: Jan. 10, 2019

(30) Foreign Application Priority Data
Aug. 4, 2016 (DE) 10 2016 009 525.3

(51) Int. Cl. F16K 31/60

(52) U.S. Cl. CPC F16K 31/60

(57) ABSTRACT

The invention relates to a valve comprising a valve housing (1) and a manually actuatable valve part (5) which is arranged therein in a longitudinally displaceable manner, said valve part controlling the free passage cross-section for fluid between the two connection points (10, 17) in the valve housing at given adjustment positions. The valve is characterized in that a latching device (55, 57) is provided between the valve housing and the valve part, which lets the valve part assume its re¬spective adjustment position only in stages and in a releasable manner.

The invention relates to a valve, having a valve housing and a manually operable valve part longitudinally movable arranged therein, which actuates the free passage cross section for fluid between two ports in the valve housing in predetermined setting position.

Manually operated valves, arguably the most widely used type of valve, are used in a wide range of fluid flow control applications to both open or shut off passage cross-sections and to provide a fluid restriction by partially opening passage cross-sections.

In the latter case, the manual operation can be difficult, if the valve in question is used in processes in which the flow rate has to have a certain magnitude and the valve part must therefore be manually adjusted to certain setting positions.

In view of this problem, the invention addresses the problem of providing a valve that facilitates manually adjusting desired setting positions.

According to the invention, this object is achieved by a valve having the features of claim 1 in its entirety.

According to the characterizing part of claim 1, a significant feature of the invention is a latching device provided between the valve housing and the valve part, which latching device ensures the valve part only assumes discrete setting positions in a releasable manner. In a simple and secure way selected passage cross sections can be set in a repetitious manner in this way, for example, starting from the fully locked or completely open state, the adjustment process is conducted in a selected number of incremental steps.

In preferred exemplary embodiments, the latching device can have individual adjacent latching webs, whose individual spacing determines the height of the individual step between two adjacent setting positions of the valve part.

With particular advantage, the arrangement can be made such that at least one latching part permanently acted on by an energy storage is provided as a further part of the latching device, which, for attaching the valve part, engages with spaces between two adjacent latching webs of the latching device in a predetermined setting position with zero play and is manually disengaged from this pair of latching webs against the action of the energy storage. The adjustment process is particularly user-friendly owing to the manual releasability of the latch.

Preferably, for obtaining identical increments, the spacing between the individual latching webs of every pair is identical.

With particular advantage, the latching part may be formed of a catch ball, upon which a compression spring acts as energy storage, wherein the diameter of the catch ball is adapted to a free space between two adjacent latching webs. As a result, the latching and thus the setting position of the valve part are free of play.

In particularly advantageous exemplary embodiments, a spindle drive is provided for generating the adjusting manual movement of the valve part, in which a male thread of the slider-like valve part engages with an assignable female thread in the valve housing in every adjustment setting position of the valve part.

With particular advantage, the arrangement there can be made such that the valve part has a handle, preferably in the form of a thumb wheel, at its free end protruding over the valve housing for the manual operation and bears a valve disc at its other free end, which interacts with a conical valve seat in the valve housing thereby forming an aperture or restriction for the passage cross-section. In this way, the operator can easily and conveniently adjust the desired setting positions by turning the handle.

In advantageous exemplary embodiments, at least one marking visible from the outside is present at the protruding free end of the valve part, which provides information about the individual setting position of the valve part based on at least one marking on the housing. In conjunction with the latching device, the desired setting positions are made visible to the operator in a particularly simple manner.

With particular advantage, the arrangement can be made in this case such that the valve has markings for a rough and a fine adjustment, wherein the respective marks for the rough adjustment are located on the shaft of the valve part between the handle and the valve housing and the marks for fine adjustment are on the handle itself.

With particular advantage, the latching device may be designed such that it emits an acoustic and/or optical feedback to an operator while the valve part is being actuated. For an acoustic feedback, the latching device can be technically designed such that by selecting the amount of the prestress of the compression spring acting on the catch ball and/or the shape of the latching webs, the latching process generates a clicking sound perceptible to the operator. The operator has haptic feedback through the torque increments felt by the operator as the handle rotates.

The invention is explained in detail below, with reference to an exemplary embodiment shown in the drawing.

In the Figures:

FIG. 1 shows a perspective oblique view of the exemplary embodiment of the valve according to the invention;

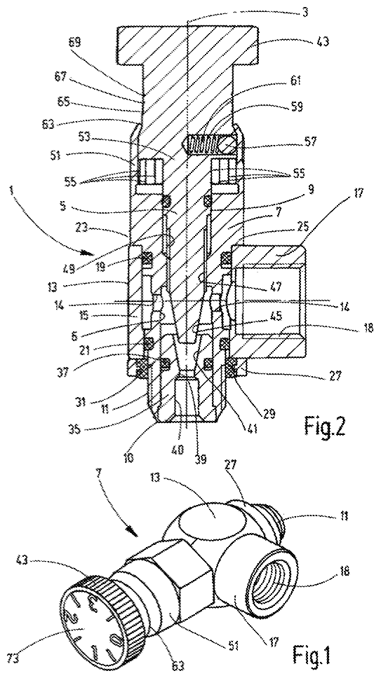

FIG. 2 shows a longitudinal section through the exemplary embodiment;

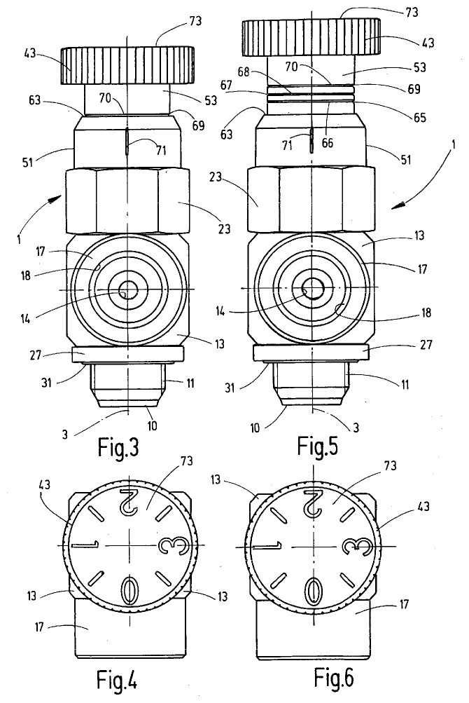

FIGS. 3 and 4 show a side view and top view of the exemplary embodiment for the closed setting position; and

FIGS. 5 and 6 a side view and top view of the exemplary embodiment for the open setting position.

Below the invention is explained with reference to an exemplary embodiment, in which the valve is formed in the manner of a cartridge having a valve housing 1, which defines a setting position or traversing axis 3 for movements of a positionally adjustable valve part 5. The multi-part valve housing 1 has a base body 7, which has an inner passage 6 coaxial with the axis 3, in which a guide 9 is formed for movements of the valve part 5. In the exemplary embodiment shown as screw-on part, a male thread 11 is provided at the end 10 of the base body 7 depicted at the bottom in FIGS. 2 and 3 and 5 below. For screwed connections to a fluid-conveying component established by means of the male thread 11, the end 10 of the body 7 forms a first fluid port.

To form a second fluid port, the multipart valve housing 1 has, as a further housing part, a connection body 13, which consists of a sleeve part 15 penetrated by the main body 7 and a tubular body 17 protruding at right angle therefrom, which forms the second fluid port of the housing 1. The sleeve part 15 of the connecting body 13 penetrated by the main body 7 is sealed against the base body 7 by means of sealing rings 19 and 21. The pipe section 17 forming the second port has a female thread 18 for a screwed connection to a relevant fluid line. In the area inside the sleeve part 15 of the connection body 13, the base body 7 has a ring of radial bores 14, which connect the passage 6 to the interior of the sleeve part 15 and thus to the port on the tubular body 17.

An external hexagon 23 adjoins the longitudinal section of the main body 7 that extends through the connecting body 13, enlarging the outer diameter of the main body 7 while forming one step surface 25. It constitutes a contact surface for the axial attachment of the connection body 13 on the base body 7 to which the connection body 13 is attached by a retaining ring 27 if it is secured by the screw connection 11 formed by the male thread at the connection end 10. The retaining ring 27 has a radially inwardly projecting annular rib 29 on the inside, which holds a gasket 31, which forms a seal on the screw formed by the male thread 11. In the end area of the base body 7, extending from the connection end 10 into the interior of the connection body 13, an insert body 35 is pressed into the inner passage 6, which forms the continuation of the guide 9 in the base body 7, the outer side of which is sealed by a sealing ring 37 in the passage 6. The insert body 35 has an inner through hole, which extends from the outer port end 10 over half the length of the insert body 35 coaxial to a bore portion 46 and circular cylindrically to a constriction 39, from where the bore expands conically to form a valve seat 41 to the upper end.

The valve part 5 has a round thumbwheel 43 at its free end projecting from the valve housing 1 for manual rotary actuation. At the inner end opposite thereto, the valve part 5 forms a valve disc 45, which controls, in conjunction with the conical valve seat surface 41, the size of the passage cross section, according to the axial setting positions of the valve part 5, starting from the fully open position shown in FIG. 2 to a closed position, in which the valve cone 45 is moved in contact against the valve seat 41 and blocks the passage. Intermediate positions cause a corresponding fluid throttling. A spindle drive is provided for the movements of the valve part 5, which spindle drive is formed by a female thread 47 on the guide 9 of the base body 7 and a corresponding male thread 49 is formed on the valve part 5.

The valve housing 1 forms a latching device in the housing section 51, which specifies setting stages for the setting positions of the valve part 5, which is located between the outer hexagon 23 and the adjacent free end of the base body 7. The latching device effective between the inner wall of the housing section 51 and the shaft 53 of the valve part 5 has a ring of axially extending latching webs 55 on the inner wall of the housing section 51, which webs form radially inwardly projecting latching ribs at equiangular intervals and which specify stepped rotational positions for rotational adjustment movements of the valve part 5 in conjunction with a latching part engaging with the interstices between the latching ribs. As latching part 5, a catch ball 57 is provided in a transverse bore 59 on the shaft 53 of the valve part 5, which ball is radially outwardly pre-stressed by a compression spring 61 for latching engagement between the latching webs 55. Located at the part of the shaft 53 of the valve part 5 protruding over the housing end 63, parallel annular grooves 65, 67 and 69 extend perpendicular to the axis 3, the groove base of which is colored to establish optical markings 66, 68, 70, signaling the axial position of the signal shaft 53 relative to the housing end 63 and thus indicating the setting position of the valve disc 45 relative to the valve seat 41. The arrangement and the axial distances of the annular grooves 65, 67, 69 constituting markings 66, 68, 70 can be selected such that at a given pitch of the spindle drive of the valve part 5 for a screwed-in setting position and in the closed position of the valve, as shown in FIG. 3, a marking 70 is visible in the shape of the annular groove 69 and, for a fully open setting position, all annular grooves 65, 67 and 69 i.e. the markings 66, 68, 70 are visible, cf. FIG. 5. In the intermediate positions, the distance between two annular grooves can correspond to one revolution of the thumb wheel 43.

While the markings 66, 68, 70 constitute the optical indicator for a rough adjustment, for fine adjustment an axially extending visual mark 71 is formed in the vicinity of the housing end 63 on the valve body 1, cf. FIGS. 3 and 5, to which a rotary scale at the top 73 of the thumb wheel 43, cf. FIGS. 4 and 6, has been assigned, which signals the rotational steps of the valve part 5 assigned to the catch increments and thus the fine adjustment corresponding to the division of the latching webs 55. In addition to the optical display for the rough and fine adjustment, the operator is aided by an acoustic indication signaling the latching increments due to the click sound caused by the jumps of the catch ball 57 when running across the ribs of the latching webs 55 and falling into the interstices. The discrete torque changes the operator feels during the rotational operation of the thumb wheel 43 when running across the latching ribs of the latching webs 55 provide an additional haptic indication.

1. A valve, having a valve housing (1) and a manually operable valve part (5) longitudinally displaceable arranged therein, which actuates the free passage cross section for fluid between two ports (10, 17) in the valve housing (1) in predetermined setting positions, characterized in that a latching device (55, 57) is provided between the valve housing (1) and the valve part (5), which latching device ensures the valve part (5) only assumes discrete setting positions in a releasable manner.

2. The valve according to claim 1, characterized in that the latching device (55, 57) has individual adjacent latching webs (55), whose individual distance from one another determines the height of the respective step between two adjacent setting positions of the valve part (5).

3. The valve according to claim 1, characterized in that at least one latching part (57) permanently acted on by an energy storage (61) is provided as a further part of the latching device (55, 57), which, for attaching the valve part (5), engages with spaces between two adjacent latching webs (55) of the latching device (55, 57), in a predetermined setting position without play and is manually disengaged from this pair of latching webs (55) against the action of the energy storage (61).

4. The valve according to claim 1, characterized in that for obtaining equal increments, the individual latching webs (55) of every pair are arranged equidistant.

5. The valve according to claim 1, characterized in that the latching part is formed of a catch ball (57), which is acted upon by a compression spring (61) as energy storage and that the diameter of the catch ball (57) is adapted to a free space between two adjacent latching webs (55).

6. The valve according to claim 1, characterized in a spindle drive is provided for generating the adjusting manual movement of the valve part (5), in which a male thread (49) of the slider-like valve part (5) engages with an assignable female thread (47) in the valve housing (1) in every adjustment setting position of the valve part (5).

7. The valve according to claim 1, characterized in that the latching webs (55) extend in parallel alignment with the relevant adjustment movement of the valve part (5) on the inner wall of the valve housing (1) and that the spring-loaded latching part (57), mounted in the valve part (5), engages transversely thereto with the spaces between the latching webs (55).

8. The valve according to claim 1, characterized in that the valve part (5) has a handle, preferably in the form of a thumb wheel (43), at its free end protruding over the valve housing (1) for the manual operation and bears a valve disc (45) at its other free end, which interacts with a conical valve seat (41) in the valve housing (1) thereby forming an aperture or restriction for the passage cross-section.

9. The valve according to claim 1, characterized in that at least one marking (73) visible from the outside is present at the protruding free end of the valve part (5), which provides information about the individual setting position of the valve part (5) based on at least one marking on the housing (1).

10. The valve according to claim 1, characterized in that it has markings for a rough and a fine adjustment, wherein the respective marks (66, 68, 70) for the rough adjustment are located on the shaft (53) of the valve part (5) between the handle (43) and the valve housing (1) and the marks (71) for fine adjustment are located on the valve housing itself.

11. The valve according to claim 1, characterized in that the latching device (55, 57) provides acoustic and/or haptic feedback to operator when operating the valve part (5).
